(19) United States
(12) Patent Application Publication
(10) Pub. No.: US 2006/0036539 A1
(43) Pub. Date: Feb. 16, 2006

(54) System and method for anonymous gifting

(76) Inventor: James D. Tombroff, Jacksonville, FL (US)

Correspondence Address: Mark J. Young, Suite 227, 9951 Atlantic Blvd., Jacksonville, FL, 32225, US

(21) Appl. No.: 10/918,516

(22) Filed: Aug. 14, 2004

(51) Int. Cl. G06Q 40/00

(52) U.S. Cl. 705/39

(57) ABSTRACT

An anonymous gifting system exemplary includes an interface for subscribers to place orders online; a server configured to receive orders from subscribers for goods and/or services from participating vendors, associate each order with a subscriber's alias, and transmit each order to a vendor for processing and delivery of the ordered goods and services

### FIELD OF THE INVENTION

This invention generally relates to online dating, and more particularly, to a system and methodology which enables subscribers to anonymously give and receive gifts.

### BACKGROUND

In recent years, online dating has gained popularity as a medium to meet romantic partners. Online dating offers convenience and privacy as key benefits of meeting people over the internet. The anonymity of online dating allows subscribers to explore possible partners from the convenience of their own home, at any time, even while in their pajamas. Indeed, if used effectively, an online dating service can be a great tool for identifying prospective partners, getting to know people, and screening out undesirables. Subscribers may interact extensively in virtual anonymity before deciding whether to divulge their real name and contact information or rendezvous briefly to check each other out face to face. Impersonal, boilerplate and suspicious messages can be readily discarded in seconds. Through such interaction, a subscriber can learn a lot about a potential partner's interests to see if they mesh before taking the next step.

Online dating systems known in the art, such as the system described in U.S. Pat. No. 6,061,681, enable anonymous online communication, telephone communication and/or video conferencing. While these methods of communication are extremely useful for learning about a potential match, they are somewhat limited. They do not facilitate truly gauging or expressing generosity, spontaneity, sincerity, thoughtfulness, affluence and tastes. All of these characteristics can be important for compatibility. Another mode of anonymous communication is needed to add this dimension to online courting.

The invention is directed to overcoming one or more of the problems as set forth above.

### SUMMARY OF THE INVENTION

To solve one or more of the problems set forth above, in an exemplary implementation of the invention, a system which enables anonymous gifting (i.e., giving/receiving gifts) is provided. The exemplary system includes a user interface for subscribers to place orders online; a server configured to receive orders from subscribers for goods and/or services from participating vendors, associate each order with a subscriber's alias, and transmit each order to a vendor for processing and delivery of the ordered goods and services.

### BRIEF DESCRIPTION OF THE DRAWINGS

The foregoing and other objects, aspects and advantages will be better understood from the following detailed description of an embodiment of the invention with reference to the drawings, in which:

FIG. 1 shows a high-level block diagram of a computer network upon which an exemplary implementation of the invention may be implemented;

FIG. 2 shows a high level block diagram of modules of a web-based system in accordance with an exemplary implementation of the invention;

FIG. 3 is a flow diagram illustrating steps of an exemplary methodology in accordance with one implementation of the invention;

FIG. 4 is a flow diagram illustrating steps of an exemplary registration process in accordance an implementation of the invention;

FIG. 5 is a flow diagram illustrating steps of an exemplary account management process in accordance with an implementation of the invention; and

FIG. 6 is a flow diagram illustrating steps of an exemplary preference management process in accordance with an implementation of the invention.

### DETAILED DESCRIPTION

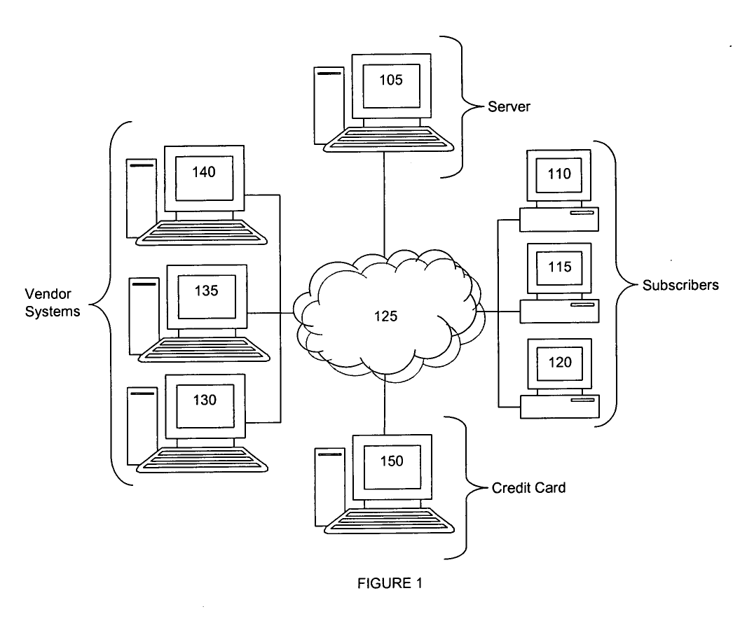

Referring to FIG. 1, a high-level block diagram of an online system in accordance with an exemplary implementation of the invention is shown. A server 105 hosts software for storing data and performing functions according to the invention. Subscribers (e.g., individuals seeking romantic partners) using computing devices 110-120 access the server 105 to perform various functions, such as registering, managing their accounts, updating information pertaining to them, and performing transactions. Access to the server 105 by the plurality of subscribers 110-120 is preferably via one or more data communications networks, which may include the Internet 125. In one embodiment, vendors, using computing devices 130-140, market their goods and/or services to subscribers. The vendors access the server 105 to perform various functions, such as registering, managing their accounts, updating information pertaining to them, and receiving and processing transaction requests.

An exemplary server 105 is comprised of a computer system, having a bus for communicating information, a central processing unit (CPU), a read only memory (ROM), a random access memory (RAM), a mass storage device, and communications equipment. The storage device may include a hard disk, CD-ROM drive, DVD drive, tape drive, memory (e.g., RAM, ROM, Compact Flash RAM, PCMCIA RAM) and/or other storage equipment. An input device such as a keyboard, touch sensitive screen, a pointing device (e.g., a computer mouse, touch pad or joystick) and the like may also be provided. Software such as network operating system software is stored on and executable on the server 105. These elements are typically included in many computer servers. Indeed, the aforementioned server 105 is intended to represent a broad category of computer systems capable of functioning as a computer server and hosting application software for network access and use by subscribers in accordance with the present invention. Of course, the server 105 may include fewer, different and/or additional elements, functioning as a single server or as a distributed system, provided it is capable of performing functions in accordance with the present invention.

The server 105 hosts (i.e., provides clients with access to) information, documents and software needed to provide functionality and enable performance of methodologies in accordance with an exemplary embodiment of the invention. For example, the server 105 may include web page information and documents (e.g., HTML and XML code), applets and application software, which manage subscriber access and use, processes transactions and manage databases for subscriber data.

A plurality of subscribers access the server 105 using compatible computing devices 110-120 with network connectivity. By way of example, such devices 110-120 may include personal computers, personal digital assistants or any similarly equipped electronic computing devices. Although three subscriber computers 110-120 are shown for illustrative purposes, any number of subscriber computers may be used in accordance with the invention. Additionally, various forms of network connectivity may be used by the subscriber computers 110-120 to access the server. Subscriber system may include an operating system, a web browser configured to display HyperText Markup Language (HTML) documents sent by the server system. Such browsers may also utilize client-side scripting languages such as Javascript and VB Script.

Those skilled in the art will appreciate that a system according to the invention can utilize many different types of communications networks. For example, a proprietary Wide Area Network (WAN) or a public WAN such as the Internet may be used. These networks typically employ various protocols such as the HyperText Transfer Protocol (HTTP), Extensible Markup Language (XML), and Transfer Control Protocol/Internet Protocol (TCP/IP) to communicate information between remote computer systems. A system according to the present invention may also utilize wireless networks, including those utilizing Global System for Mobile (GSM), Code Division Multiple Access (CDMA) or Time Division Multiple Access technology, and the Wireless Application Protocol (WAP). A system according to the invention may utilize any, or any combination of, such communications networks. As such, although the subscriber systems 110-120 are represented as being personal computer systems, as discussed above, any electronic device capable of interfacing with a communications network may be used, including kiosks, personal digital assistants and mobile phones.

A plurality of vendors may access the server 105 using compatible computing devices 130-140 with network connectivity. Each exemplary vendor system 130-140 is comprised of a computer system, having a bus for communicating information, a central processing unit (CPU), a read only memory (ROM), a random access memory (RAM), a mass storage device, and communications equipment. The storage device may include a hard disk, CD-ROM drive, DVD drive, tape drive, memory (e.g., RAM, ROM, Compact Flash RAM, PCMCIA RAM) and/or other storage equipment. An input device such as a keyboard, touch sensitive screen, a pointing device (e.g., a computer mouse, touch pad or joystick) and the like may also be provided. Software such as network operating system software is stored on and executable on the server 130-140. These elements are typically included in many computer servers. Indeed, the aforementioned vendor system 130-140 is intended to represent a broad category of computer systems capable of functioning as a vendor computing platform and hosting application software for e-commerce in accordance with the present invention. Of course, the vendor system 130-140 may include fewer, different and/or additional elements, functioning as a single server or as a distributed system, provided it is capable of performing functions in accordance with the present invention.

The vendor system 130-140 hosts information, documents and software needed to provide functionality and enable performance of e-commerce methodologies in accordance with an exemplary embodiment of the invention. For example, the vendor system 130-140 may include web page information and documents (e.g., HTML and XML code), applets and application software, which manage subscriber access and use, processes transactions and manage databases for subscriber data.

A credit card (i.e., credit, debit and smart card) processing gateway 150 is also provided. By way of example and not limitation, an SET Secure Electronic Transaction (trademark and service mark owned by SET Secure Electronic Transaction LLC) protocol may be used as a method for secure processing of bankcard transactions over a public network such as the Internet. SET, an open standard, multi-party protocol for conducting secure bankcard payments over the Internet, provides message integrity, authentication of all financial data, and encryption of sensitive data. SET is a 3-party protocol involving a cardholding consumer, a vendor, and a payment gateway operating on behalf of the acquiring bank. Credit card transactions may be processed by the server 105, in which case the server may electronically transfer all or a portion of the net proceeds from the credit card transaction to the vendor from which goods and/or services were purchased. Alternatively, credit card transactions may be processed by the vendor 130-140, in which case the purchasing subscriber's credit card information may be communicated from the subscriber's computer 110-120 to the server 105 and then to the vendor system 130-140, or from the subscriber's computer 110-120 to the vendor's system 130-140.

Illustratively, when a subscriber purchases something from a vendor using a credit or debit card, the subscriber's computer 110-120 sends a consumer payment request via the network 125 to the server 105. The server 105 or vendor 130-140 forwards the subscriber's payment request via the network 125 to an acquirer gateway 150 operating on behalf of an acquirer bank (not shown). The credit card processing gateway 150 passes the subscriber's payment request to the acquirer bank over a private network path. The acquirer bank sends the consumer's payment request to the card issuing bank over a private network to check whether the subscriber's credit or debit card account is active and sufficient for the proposed transaction with the vendor. The issuing bank, as the card issuer, authorizes the transaction in a message sent over private network to the acquiring bank. The acquiring bank sends the transaction authorization over a private network to the credit card processing gateway 150, signing the message with the acquiring bank's digital signature. The credit card processing gateway 150 forwards it over the internet 125 to the server 105 or vendor 130-140, authorizing the server 105 or vendor 130-140 to proceed with the transaction. Once the server 105 or vendor 130-140 has received the transaction authorization from the credit card processing gateway 150, the server 105 or vendor 130-140 completes the sales transaction with the subscriber. Then later, the server 105 or vendor 130-140 sends a message over internet path 125 to the credit card processing gateway 150 to capture the transaction and get paid. The credit card processing gateway 150 then sends a payment message over the Internet 125 to the server 105 or vendor 130-140. At the end of the business day, the acquiring bank will settle accounts with the issuing bank over the private network. Thus, the system may serve as a payment intermediary between a vendor and a purchasing subscriber. Net payments received for purchased goods and services (perhaps, less a commission and/or a transaction fee), may be credited to a vendor's account of choice.

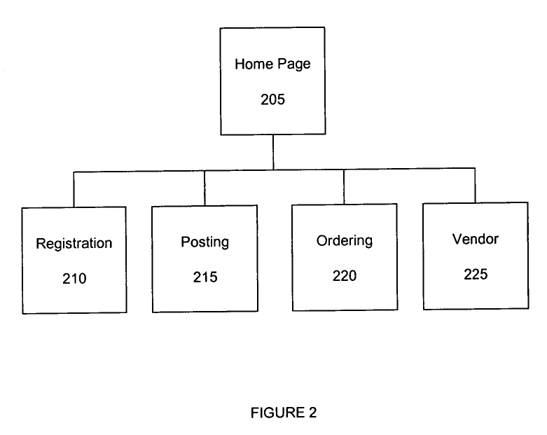

Referring now to FIG. 2, a block diagram of the application software implemented on the server 105 is provided. The application software may include web page information and documents (e.g., HTML and XML code), applets and application software and other executable code, configured to manage subscriber access and use, processes transactions and manage databases for subscriber data. The software may be conceptually divided into modules. A home page 205 provides user access to various modules, such as registration 210, posting 215, ordering 220, and vendor 225 modules. Access may be provided via hyperlinks or other web-based features for facilitating access.

The registration module 210 is used to collect subscriber information and enroll subscribers. Requested subscriber information may vary according to the particular type of subscriber. The information may include identification information (e.g., name, address, telephone numbers, email address, etc . . . ), a user name and password, and payment information, such as credit card information for paying subscribers.

Optionally, the registration module 210 may also be configured to request information and permissions needed to verify the credentials of a subscriber. For example, the module 210 may request a subscriber's social security number, date of birth and/or driver's license number as well as permission to access a third party database (e.g., a credit reporting, criminal background, department of motor vehicles database) for verifying credentials. If entered information does not match the information from the independent database, or if a criminal record is revealed, the prospective subscriber may be denied access to the system.

As an integral part of the registration process, each subscriber may be required to enter an alias. The alias may be the subscriber's user name, or another unique name chosen by the subscriber for identification to other subscribers. The server 105 is configured to associate the alias with the subscriber's account. The system uses the alias for a subscriber to communicate with other subscribers without disclosing an actual identity. The system 105 reveals only a subscriber's alias to another subscriber. All electronic communications from one subscriber to another using the system identify each subscriber only by their alias. A subscriber's true identity and contact information are not revealed by the system to another subscriber. Of course a subscriber is free to communicate his or her actual identity to another subscriber.

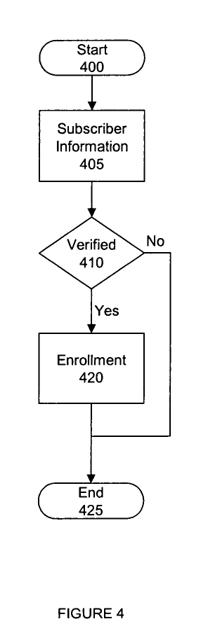

Referring now to FIG. 4, a high-level flowchart of an exemplary registration process is provided. In step 405 subscriber information is gathered. Optionally, the subscriber's credentials may be verified, as in step 410. Next, if the subscribers credentials are verified, the subscriber is enrolled, as in step 420. However, if the credentials are not verified, enrollment does not occur and the process ends. After completing registration, the subscriber may logout 425. Thereafter, the subscriber may log into and access the system and use all features within the scope of the subscriber's permission.

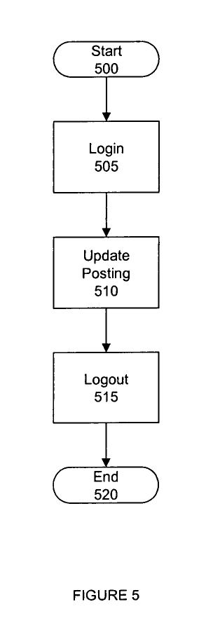

The posting module 215, as shown in FIG. 2, provides subscribers access to their profile. Referring to now FIG. 5, after logging into the system 505, a subscriber may access and manage posted information 510, such as (for example) updating text, a photograph image, audio, and/or a movie file. One or more of these elements are typically included in online dating postings. Indeed, the aforementioned posting module 215 is intended to represent a broad category of posting modules suitable for an online dating system. Of course, the posting module 215 may include fewer, different and/or additional elements without departing from the scope of the present invention. Upon completing any data entry and updates, the subscriber may logout 415. Thereafter, the system will use the updated posted information.

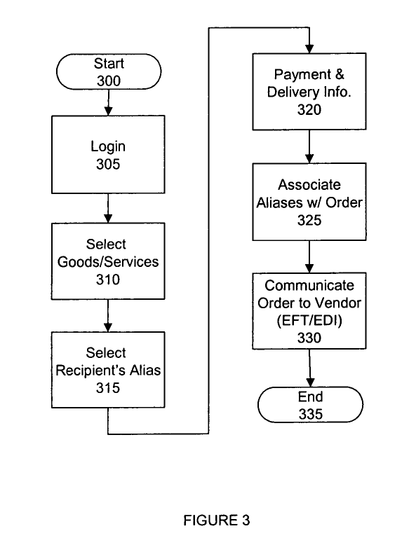

The ordering module 220, as shown in FIG. 2, provides subscribers access to goods and services which may be purchased and delivered to subscribers. Referring to now FIG. 3, after logging into the system 305, a subscriber (i.e., a purchasing subscriber) may select goods and/or services offered by participating vendors, as in step 310. The purchasing subscriber may also select an alias of a subscriber (i.e., a receiving subscriber) to receive the goods and/or services, as in step 315. Next, the subscriber may enter payment information, such as a valid credit card number and expiration date, and a delivery method as in step 320. Payment processing may proceed as described above. A system according to an exemplary embodiment of the invention will automatically associate the receiving subscriber's actual address with the order based on the receiving subscriber's alias, without revealing the receiving subscriber's actual personal information (e.g., address and identification) to the purchaser. A system according to an exemplary embodiment of the invention will automatically associate the purchasing subscriber's alias with the order, based on the purchasing subscriber's identification, without revealing the purchasing subscriber's actual personal information (e.g., address and identification) to the receiving subscriber, as in step 325. The order is communicated to the vendor for fulfillment, as in step 330. However, the vendor does not receive the purchasing subscriber's actual personal information. Instead, the vendor receives the purchasing subscriber's alias, the receiving subscriber's actual name and address, the dating system's address as a return address, and payment confirmation, as in steps 325 and 330. Alternatively, if the vendor receives the purchasing subscriber's actual personal information, the vendor will also receive the purchasing subscriber's alias and the dating system's address. In such an implementation, the vendor is instructed to (and has agreed to) omit the purchasing subscriber's personal information from the goods/services and any information (e.g., receipts) provided with the goods/services to the receiving subscriber. Thus, the receiving party will receive the purchasing subscriber's alias, but will not receive the purchasing subscriber's personal information from the dating system or from the vendor.

Advantageously, an exemplary implementation of the invention includes a restaurant module 225 which provides information, functions and tools for subscribers to procure catering services and for restaurants to promote their services in a manner convenient for subscribers. The restaurant module provides tools for searching, presenting menus, placing orders, rendering payment and managing transaction information.

Searching tools enable identification of restaurants in the general vicinity of a physician. The search may be based upon a street address or zip code of a physician's office. Additional search parameters (or filters) may include other relevant criteria, such as price ranges, type of cuisine and available days and hours of delivery. Subscribing restaurants may update their information using the account module. Restaurant searching tools may be accessed from links in various parts of the system. Using the tools, a subscriber may efficiently locate a restaurant suitable for catering a mealtime meeting.

The restaurant module may also include a menu presentation tool. Menus may be provided in a screen displayable format (e.g., HTML or XML) as well as in a printer-friendly format (e.g., Adobe Acrobat® portable document format [.pdf]). Subscribing restaurants may update their menus using the account module.

To facilitate payments, a subscriber's credit card information may be stored as account information. With each placed order, a subscriber may have the choice of using the stored credit card information, or using another credit card. Credit card (including debit and smart card) purchases may be processed in a conventional manner as described above. Advantageously, a subscriber will not need to re-enter all of his/her default billing information for each transaction, as that information will be stored by the system's account module.

Advantageously, an exemplary implementation of the invention includes a vendor module 225 which allows vendors to manage their posted products and contact information; track orders; run reports and perform other functions. In one embodiment, product information for a vendor is uploaded to and stored on the server 105. In another embodiment, product information for a vendor remains on the vendor's system 130-140, where it may be accessed from the server by links, frames or other forms of remote connectivity. A vendor representative must login before performing any system activities. Only registered vendors will have a valid account. An account for a vendor is established when the vendor registers with the system. A vendor representative may initiate registration via a web interface. The signup process collects basic vendor information, including the information necessary to pay the vendor, and a password, which will be used to create a user account for the vendor. Once the vendor is approved (which may be automated), the vendor may be sent an email containing a unique user id which can be used to login to the system.

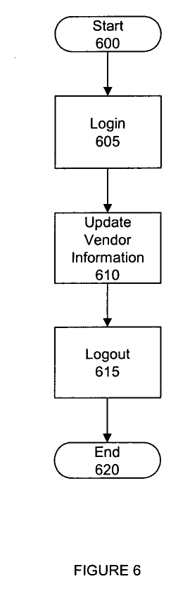

Referring now to FIG. 6, after logging in, as in step 605, a vendor representative is taken to the vendor module. The vendor may then access and change vendor information, as in step 610. Such information may include the vendor's password and other account information. The vendor may also manage purchase and product information, including basic vendor information such as name, address, logo; contact information for admin, finance, returns, support and order notification; product information, such as product name, description, attributes (e.g., size, weight, volume, color, etc.), price information, a small (e.g., thumbnail) image, a large higher resolution image, product codes, and quantity/weight/volume; payment information such as acceptable credit cards; shipping information by price, items, weight/size and available shipping mode; and tax information to set tax rates for states in which taxes are collected. Upon completing all updates, the vendor may logout, as in step 620.

Advantageously, the system provides a vehicle for combining purchasing power for the overall benefit of each individual subscriber. Demand can be aggregated across multiple subscribers. The aggregated demand may help secure discounts for goods and services. Subscribing subscribers may procure services at reduced prices that result from higher purchasing volumes. Thus, the system strengthens the purchasing power of subscribers.

A system according to an exemplary implementation of the invention provides several revenue generating opportunities. Some or all subscribers may be charged subscription fees. Service charges may be assessed for processing product orders. Vendors may be charged advertising fees for promoting their goods and services. Pursuant to an affiliate program, the system operator may be entitled to a commission for sales of products and services. These and other fees and charges may be assessed to cover costs associated with implementing and managing the system and to make it a profitable sustainable enterprise.

A system according to an exemplary implementation of the invention may be implemented in many different modes. For example, the system may be an integral part of an online dating service. Alternatively, the system may be a service offered by a walk-in dating service. The system may also be implemented as a service offered through telephone-based dating services.

While the invention is described as a feature of an on-line dating service, those skilled in the art will appreciate that it may be implemented in connection with other services. By way of example and not limitation, the invention may be utilized by organizations or workplaces to enable their members and/or staff to anonymously exchange gifts.

Those skilled in the art will appreciate that the terms module and tool are used for reference convenience to conceptually identify functions and groups of functions. The functions may be implemented using one or more software, firmware and/or hardware components, alone or in combination with other components without departing from the scope of the invention. Tools and modules may be arranged as described above or in a different manner without departing from the scope of the invention. Additionally, each component may implement one or more functions or parts of functions, in groupings as described above, or in different groupings without departing from the scope of the invention.

While the invention has been described in terms of various embodiments and implementations, those skilled in the art will recognize that the invention can be practiced with modification within the spirit and scope of the appended claims.

We claim the following:

1. An anonymous gifting system comprising:
a server, said server being configured to receive orders from subscribers;
subscriber data for a plurality of subscribers stored on said server, said subscriber data including, for each subscriber, an alias and an actual identification;
a plurality of vendor computers communicatively coupled to said server, said server being adapted to communicate orders and subscriber aliases to the vendor computers, said vendor computers being adapted to fulfill orders without divulging a subscriber's actual identification to another subscriber.

2. The system of claim 1, further including a credit card gateway configured to process credit card transactions.

3. The system of claim 1, further including a subscriber registration module.

4. The system of claim 1, further including a posting management module.

5. The system of claim 1, further including an ordering module.

6. The system of claim 1, further including a vendor module.

7. A method of anonymous gifting comprising:
establishing an account for each of a plurality of subscribers with a server, each of said accounts including an actual identification and an alias for the subscriber,
communicating an order and subscriber aliases;
fulfilling the order without divulging a subscriber's actual identification to another subscribe.
